(19) United States
(12) Patent Application Publication
(10) Pub. No.: US 2013/0139426 A1
(43) Pub. Date: Jun. 6, 2013

(54) SYSTEM FOR HANDGUN GRIP AREA EXTENSION

(71) Applicant: Murrill L. Baxley, Ovilla, TX (US)

(72) Inventor: Murrill L. Baxley, Ovilla, TX (US)

(21) Appl. No.: 13/310,903

(22) Filed: Dec. 5, 2011

(51) Int. Cl. F41C 23/10; B23P 11/00

(52) U.S. Cl. 42/71.02; 29/428

(57) ABSTRACT

The present invention defines a system (200), comprising various structures and methods, for increasing the effective grip area of a compact or sub-compact pistol (100) in a secure, yet easily removable manner. A base collar portion (202) is provided, having a magazine channel (214) formed through it. The base collar portion is adapted to securely connect with the bottom (218) of a desired pistol grip (102). An engagement shaft (204) is disposed along the along the base collar portion. The engagement shaft is adapted for insertion into a corresponding cavity (110) within the desired pistol grip—usually along a backstrap portion of the desired pistol grip. The engagement shaft secures contact between the base collar portion and the desired pistol grip once fully inserted into the corresponding cavity.

### TECHNICAL FIELD OF THE INVENTION

The present invention relates generally to the field of handgun frames and, more particularly, to apparatus and methods for extending the grip area of a handgun.

### BACKGROUND OF THE INVENTION

Modern semi-automatic pistols are generally produced in a variety of predetermined sizes and form-factors, including standard (or full-sized), compact and sub-compact. A user may select a particular pistol size based upon a number of factors, such as the pistol's intended use, operating environment, and performance characteristics. Typically, a full-sized pistol will hold more rounds of ammunition in its magazine than a compact or sub-compact pistol, and will have a longer and/or larger grip area—providing improved control and shooting accuracy. Compact and sub-compact pistols are usually easier than full-sized pistols to conceal and carry, and may be easier for small users to handle.

Advanced production processes, combined with availability of synthetic and hybrid materials, have enabled handgun manufacturers to integrate a number of enhancements into pistols of all sizes. For example, anatomically formed gripping surfaces may be integrated into the grip area of a pistol to optimize hand positioning and improve control of the gun. Unfortunately, however, cost and production considerations usually limit the number of pistol variations that a manufacturer can reasonably offer in any given size. As a result, an individual interested in obtaining a pistol from a particular manufacturer is typically limited to choosing from a handful of models—which may or may not provide a desired combination of grip area and barrel length that is best for a given individual's hand anatomy or shooting style.

This limitation has given rise to a number of after-market kits and devices that allow an individual to modify the effective size and/or form-factor of a pistol's grip area. Certain devices are available to increase or decrease the size of the backstrap or frontstrap portions of the grip area, although most available devices alter only the backstrap portion. All such devices typically provide nominal improvements, however, due to the fact that the backstrap and frontstrap portions of the grip area are relatively small when compared to the side walls of the grip area. Also, such devices typically do not provide the ability to increase the overall length of the grip area to render, for example, a full-sized grip area on a compact pistol.

Other devices have been developed to provide the ability to increase the effective length of the grip area, and to extend the side wall portions as well as the frontstrap and backstrap portions. These devices are generally referred to as magazine sleeves, and comprise a pre-formed sleeve that slides down to the bottom of a full-sized magazine. The sleeve is typically formed such that, once the sleeve is disposed upon a full-sized magazine and once the full-sized magazine is inserted into a compact pistol, the sleeve aligns with and replicates the contour of the pistol grip area—effectively changing the compact grip area into a full-sized grip area. While such devices are helpful, they are limited by their deployment on the magazine. Once the magazine is removed, the modification is removed. If an individual needs or wants to use more than a single modified magazine with the pistol, they must either manually remove the sleeve from an empty magazine to transfer it to a loaded magazine, or they must buy and pre-position multiple sleeves upon multiple magazines. Furthermore, removal and insertion of magazines with such sleeves in place require a user to repeatedly loosen and/or adjust their dominant hand grip, which can present numerous problems that affect shooting accuracy and speed. Magazine sleeves, therefore, are typically not cost efficient or practical for high-use or combat applications.

Still other devices have been developed that attach directly to the bottom of the pistol's magazine well, below the grip area. These devices are generally referred to as magazine well extenders. Typically, these devices have a flanged form factor that flares outward from the bottom of the pistol's grip area to the bottom of the extender. They usually are designed to ease loading of magazines by providing a flared magazine receiver opening along their bottom surface. Although such devices do increase the grip area of the pistol, they do so in an irregular fashion as they typically are not formed to replicate, or be congruous with, the manufactured contour of the pistol grip area. Furthermore, the outward flanging of such devices can actually inhibit, rather than promote, optimal hand position on the grip area.

Still other devices are available that may provide extension of a pistol's grip area. Commonly, however, such devices require modifications to the gun that are either permanent or not easily removed by a user. For example, some devices require the use of a specialized tool to attach or remove the device.

As a result, there is a need for a grip area extension device or system that overcomes the aforementioned limitations of conventional solutions. This new device or system should provide all such benefits in a versatile and cost-effective manner, and be manufacturable in a number of different aesthetic styles to satisfy consumer demands.

### SUMMARY OF THE INVENTION

The present invention provides a versatile system for handgun grip area extension. The system of the present invention provides a grip area extender that attaches securely to the frame of a pistol, while remaining easy to remove and reattach. The system of the present invention provides a grip area extender that is compatible and congruous with the manufactured contour of the pistol grip area. The present invention renders the grip area of a compact or sub-compact pistol comparable to full-sized grip area, and enables easy, efficient and stable use of full-sized magazines.

The grip area extender of the present invention provides a base collar portion, upon which an engagement shaft is formed or mounted. The base collar portion comprises a frontstrap portion, a backstrap portion, and two sidewall portions joining the frontstrap and backstrap portions while forming a central, inner magazine channel through the extender. The central magazine channel of the extender is compatible in size and form factor with a pistol's magazine—allowing a magazine to pass through the channel easily but without excessive lateral movement. The outer surfaces of the sidewall, frontstrap and backstrap portions may be formed of a material and contour that matches that of the pistol's existing grip area in a model-specific fashion, or may be formed of material and contour that is generalized to two or more models.

Extending upwardly from the rear of the invention, disposed between the magazine channel and the backstrap portion, the engagement shaft is either attached to, or formed integrally as a part of, the present invention. The engagement shaft is produced with a shape and size that is compatible with a pre-existing cavity, channel, or recess formed within the grip of a pistol, along its backstrap side. When the present invention is attached to a pistol, the engagement shaft is inserted into the pre-existing cavity, channel, or recess, and fits snugly therein, to secure the grip extender to the pistol. The engagement shaft may be formed of a material and form factor that provides a simple pressure fitting to secure the grip extender to the pistol. In other embodiments, the engagement shaft may comprise one or more locking features that mechanically connect the grip extender to the pistol.

The present invention may optionally comprise one more features that further secure the grip extender to the pistol and/or improve the aesthetic appearance of the assembly. For example, a gasket or flange may extend upwardly along the upper perimeter of the central magazine channel to close the coupling between the grip extender and bottom of the pistol's magazine well.

More specifically, the present invention provides a system, comprising various structures and methods, for increasing the effective grip area of a compact or sub-compact pistol in a secure, yet easily removable manner. A base collar portion is provided, having a magazine channel formed through it. The base collar portion is adapted to securely connect with the bottom of a desired pistol grip. An engagement shaft is disposed along the along the base collar portion. The engagement shaft is adapted for insertion into a corresponding cavity within the desired pistol grip—usually along a backstrap portion of the desired pistol grip. The engagement shaft secures contact between the base collar portion and the desired pistol grip once fully inserted into the corresponding cavity.

Other features and advantages of the present invention will be apparent to those of ordinary skill in the art upon reference to the following detailed description taken in conjunction with the accompanying drawings.

### BRIEF DESCRIPTION OF THE DRAWINGS

For a better understanding of the invention, and to show by way of example how the same may be carried into effect, reference is now made to the detailed description of the invention along with the accompanying figures in which corresponding numerals in the different figures refer to corresponding parts and in which:

FIG. 1 is an illustration depicting an embodiment of a pistol frame in accordance with the present invention;

FIG. 2 is an illustration depicting one embodiment of a grip extender according to the present invention;

FIG. 3 is an illustration depicting several embodiments of a grip extender according to the present invention;

FIGS. 4a-4b are illustrations depicting one embodiment of a grip extender according to the present invention; and

FIGS. 5a-5b are illustrations depicting alternative embodiments of a grip extender according to the present invention.

### DETAILED DESCRIPTION OF THE INVENTION

While the making and using of various embodiments of the present invention are discussed in detail below, it should be appreciated that the present invention provides many applicable inventive concepts, which can be embodied in a wide variety of specific contexts. The invention will now be described and illustrated in conjunction with a system for handgun grip area extension. Certain embodiments of pistols, grip contours, magazines, backstraps, and other pistol features are illustrated and described in relation to the present invention. These specific embodiments discussed, however, merely illustrative of specific ways to make and use the invention and do not limit the scope of the invention.

A system according to the present invention provides a versatile handgun grip area extender that attaches securely to the frame of a pistol, while remaining easy to remove and reattach. The attachment may be secured by means of a pressure fitting, a pin, a screw, or any other suitable assembly. The grip area extender the present invention is compatible and congruous with the manufactured contour of the pistol grip area. The outer surface of the grip area extender may be produced to precisely match the features of a specific manufacturer's pistol (by model number, for example), or may be provided with more generalized features that are compatible with multiple pistols (all compact or subcompact pistols produced by a particular manufacturer, for example).

The present invention renders the grip area of a compact or sub-compact pistol comparable to full-sized grip area, and enables easy, efficient and stable use of full-sized magazines. The present invention extends all portions of the grip area—frontstrap, backstrap, and sidewalls—to securely encompass and house a magazine that is larger than intended for the pistol's frame. For example, the present invention may be utilized the render the grip area of a Glock sub-compact model G26 comparable or equivalent to the grip area of a Glock full-sized model G17. The present invention may be similarly utilized in conjunction with other Glock model numbers, as well as pistols from other manufacturers—such as Springfield Armory, Beretta, and Sig Sauer, for example. These model numbers and manufacturers are listed merely for illustrative purposes, and do not limit the scope of the present invention.

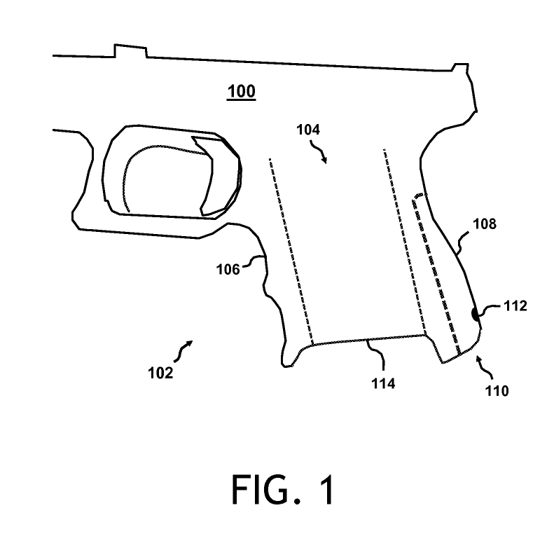

The present invention is described in greater detail now beginning with reference to FIG. 1, in which one illustrative embodiment of a sub-compact pistol frame 100 is depicted. Frame 100 comprises a grip area portion 102, formed to allow an individual to hold the pistol while firing it. A magazine well 104 is formed within the grip 102 to receive and retain a magazine. Grip 102 comprises a frontstrap portion 106 and a backstrap portion 108. A cavity 110 is formed with grip 102, behind well 104 and adjacent to backstrap 108. Grip 102 may have an accessory feature 112 disposed along the backstrap 108 to allow, for example, the attachment of a lanyard or other accessory. Depending upon the manufacturer and model number, grip 102 may optionally have a notch or recess feature 114 disposed along the lower edge of one or more of the sidewalls of grip 102.

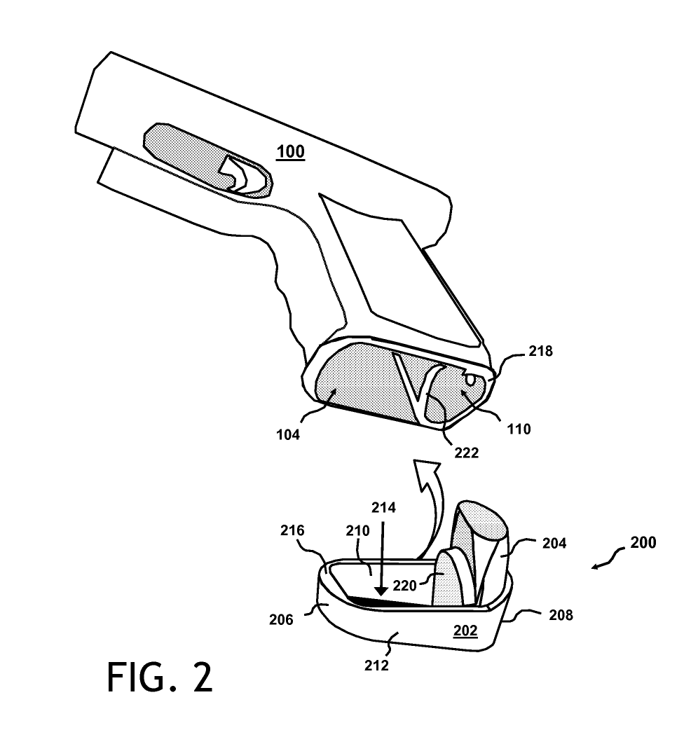

Referring now to FIG. 2, one embodiment of the present invention is illustrated in relation to frame 100. A grip extender 200 according to the present invention is depicted in proximity to frame 100. Extender 200 comprises a base collar portion 202, upon which an engagement shaft 204 is disposed. Base portion 202 also comprises a frontstrap portion 206, a backstrap portion 208, and two sidewall portions 210 and 212 joining the frontstrap and backstrap portions while forming a central, inner magazine channel 214 through the extender. Channel 214 is compatible in size and form factor with well 104—securely frame a magazine by allowing it to freely pass through the channel, while restricting excessive lateral movement of the magazine within the channel. In certain alternative embodiments, the bottom perimeter of channel 214 may be beveled, angled, curved or otherwise rendered to more securely receive the base plate of a magazine, or ease the initial insertion of a magazine into the channel. Outer surfaces of sidewalls 210 and 212, frontstrap 206 and backstrap 208 may be formed of a material and contour that matches that of the corresponding structures on grip 102 in a model-specific fashion, or may be formed of material and contour that is generalized to a plurality of models.

In the embodiment depicted, the engagement shaft is disposed between channel 214 and backstrap 208. Shaft 204 is either attached to, or formed integrally as a part of, extender 200. Shaft 204 has a shape and size that is compatible with cavity 110, and may be formed to suitably match any desired cavity 110. When extender 200 is attached to a pistol, shaft 204 is inserted into cavity 110 and fits snugly therein, to secure the grip extender to the pistol. Shaft 204 may be formed of a material and form factor that provides a simple pressure fitting to secure the extender 200 to grip 102, or alternatively, shaft 204 may comprise one or more connecting features that mechanically secure extender 200 to the grip 102.

In order to attach extender 200 to grip 102, shaft 204 is aligned with and inserted into cavity 110, and extender 200 is pressed toward grip 102 until the upper perimeter 216 of base 202 contacts the lower perimeter 218 of grip 102. Depending upon the design and composition of grip 102 and extender 200, the contact between perimeters 216 and 218 may be full or partial physical contact, or may constitute near physical proximity with only a nominal gap therebetween. In certain embodiments, an inner gasket or flange (not shown) may extend upwardly from channel 214, along the inside of perimeter 216, to further secure or complete the connection between grip 102 and extender 200. In other embodiments, extender 200 may comprise an additional alignment feature 220—such as a tab or other protuberance—that engages with an alignment feature 222—such as a notch—in well 104. Feature 220 may be disposed along the surface of shaft 204, as depicted, or may alternatively be disposed in any other position that corresponds with feature 222 of grip 102.

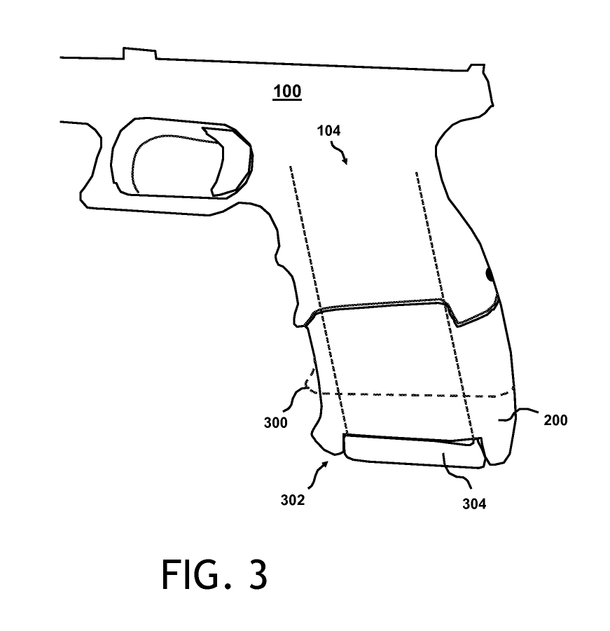

FIG. 3 depicts extender 200 fully engaged with grip 102. In the embodiment depicted, extender 200 extends the frontstrap, backstrap and sidewall portion of sub-compact grip 102 to the equivalent size and form-factor of a full-sized grip. In alternative embodiments, extender 200 may be formed or produced to extend grip 102 to the equivalent of a compact grip, as indicated by dashed line 300. In still other embodiments, extender 200 may be formed or produced to extend grip 102 to an equivalent size that is greater than full or standard size (e.g., competition grip). In the embodiment depicted, extender 200 is formed having a recess or notch 302 at the bottom of its sidewalls, adapted to receive and/or secure a base plate 304 of a magazine when the magazine is fully inserted into well 104.

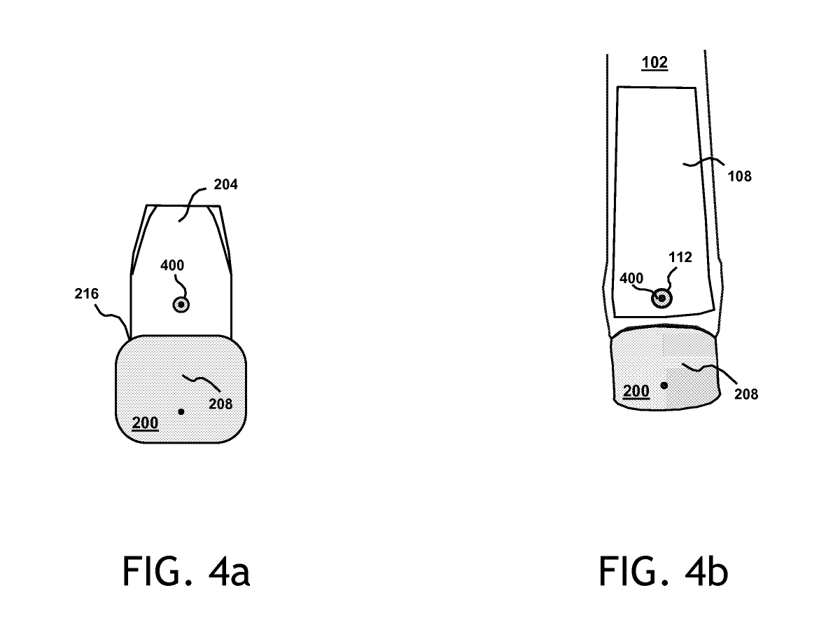

Referring now to FIGS. 4a-4b, certain aspects of a connecting feature 400 are illustrated. FIG. 4a depicts a rear view of extender 200, from which backstrap 208 and the rear portion of shaft 204 are visible. Disposed along shaft 204 is connection feature 400. FIG. 4b depicts extender 200 inserted into and fully engaged with grip 102. This figure depicts the rear view of the assembly, from which backstrap 108 and backstrap 208 are visible. Also visible is accessory feature 112.

In the embodiment depicted, feature 112 comprises a small, pre-existing aperture formed near the bottom of backstrap 108. Feature 400 is formed or disposed upon shaft 204 such that when extender 200 is fully engaged with grip 102, features 112 and 400 are in alignment and provide a secure connection for the entire assembly. In the embodiment depicted, feature 400 may comprise a small threaded chamber for receiving a screw inserted through feature 112. In alternative embodiments, feature 400 may comprise a slightly deformable member (e.g., a nodule) that clicks into and out of pressure-fit engagement with feature 400. A number of alternative insertion-type and pressure-fit embodiments of feature 400 are hereby comprehended. In certain embodiments, feature 112 may be a pre-existing feature formed by the manufacturer. In other alternative embodiments, feature 112 may be formed in an after-market fashion either by a gunsmith or end-user. In the embodiment depicted, features 112 and 400 are disposed along the backstrap portions of grip 102 and extender 200, respectively. In alternative embodiments, these features may be disposed along the sides of shaft 204 and cavity 110. In still other embodiments, these features may be formed along the surfaces of shaft 204 and cavity 110 adjacent to channel 214 and well 104, respectively. Various combinations of these alternatives are also comprehended hereby.

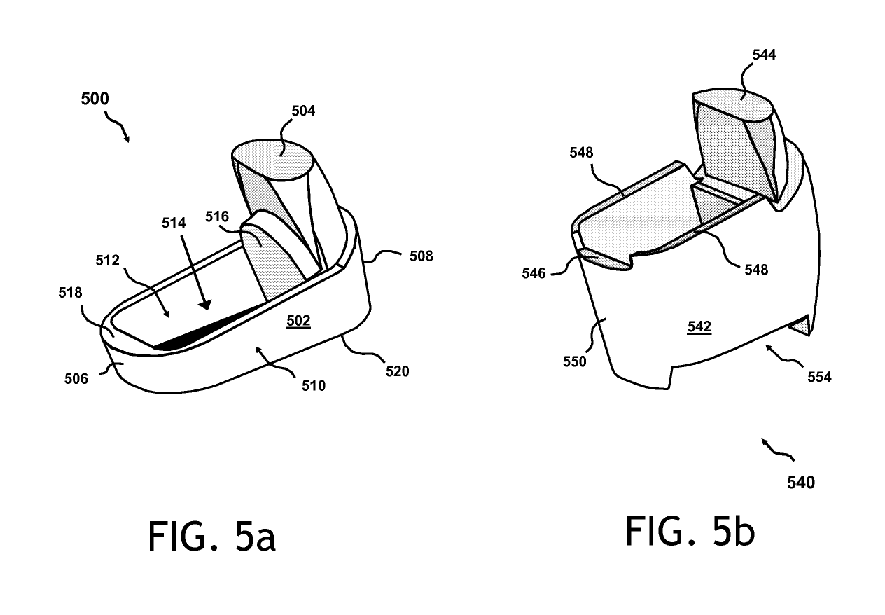

Two exemplary embodiments of a grip extender in accordance with the present invention are described now in reference to FIGS. 5a-5b. As depicted in FIG. 5a, a grip extender 500 comprises a base collar portion 502, upon which an engagement shaft 504 is disposed. Base portion 502 also comprises a frontstrap portion 506, a backstrap portion 508, and two sidewall portions 510 and 512 joining the frontstrap and backstrap portions while forming a central, inner channel 514 through the extender. As described hereinabove, channel 514 is compatible in size and form factor with the magazine well of one or more corresponding pistols, and allows a magazine to pass through easily but without excessive lateral movement. The various portions and structures of extender 500 may formed of any suitable material—metal, synthetic, composite, or some combination thereof. The exterior surfaces of extender 500 may be formed or finished with contour and texture that matches that of a corresponding pistol grip, in a model-specific fashion, or may be formed or finished with contour and texture that is generalized to a plurality of models.

In the embodiment depicted, extender 500 comprises an alignment feature 516 that engages with a corresponding alignment feature in a pistol grip. Shaft 504 may be formed of a material and form factor that provides a simple pressure fitting to secure the extender 500 to a pistol grip. For example, shaft 504 may be formed of a semi-malleable material, such as vulcanized rubber, that secures extender 500 in place by virtue of a friction fit between shaft 504 and a corresponding cavity on a pistol grip. In addition, or alternatively, shaft 504 may comprise one or more connecting features that mechanically secure extender 500 to a pistol grip, as described hereinabove. In this embodiment, extender 500 comprises an upper perimeter 518 of base 502 that is formed to contact the lower perimeter of a corresponding pistol grip, as described hereinabove. Base 502 has a lower perimeter 520 that is substantially planar.

Referring now to FIG. 5b, another embodiment of a grip extender 540 comprises a base collar portion 542, upon which an engagement shaft 544 is disposed. This embodiment is similar to extender 500, with a few notable differences. Extender 540 comprises an alignment feature that is integrally formed along the upper perimeter 546 of base 542. Alignment feature 548 comprises a raised tab that extends upwardly from each sidewall portion of base 542 and extends along perimeter 546 until terminating in the frontstrap region 550 of base 542. Feature 548 is provided to facilitate the alignment and connection between extender 540 and a corresponding pistol grip—where that grip has a notched region for receiving the base plate of a magazine.

Extender 540 comprises another alignment feature, this one integrally formed along the lower perimeter 552 of base 542. Alignment feature 554 comprises a recess that extends upwardly perimeter 552 into each sidewall portion of base 542, and extends along perimeter 552 until terminating in frontstrap region 550. Feature 554 is generally of the same size and geometry as feature 548, and is provided to facilitate receiving the base plate of a magazine.

All embodiments described herein are presented for purposes of illustration and explanation only. The specific compositions, configurations, orientations and operations of various components, systems and members may be provided in a number of ways in accordance with the present invention. The embodiments and examples set forth herein are presented to best explain the present invention and its practical application and to thereby enable those skilled in the art to make and utilize the invention. The description as set forth is not intended to be exhaustive or to limit the invention to the precise form disclosed. Many modifications and variations are possible in light of the above teaching without departing from the spirit and scope of the following claims.

What is claimed is:

1. A pistol grip extender comprising:
a base collar portion, having a central magazine channel formed through it, adapted to contact a lower perimeter of a desired pistol grip; and
an engagement shaft, disposed upon the base collar portion, adapted for insertion into a cavity within the desired pistol grip, and adapted to secure contact between the base collar portion and the lower perimeter of the desired pistol grip once fully inserted into the cavity.

2. The pistol grip extender of claim 1, wherein the engagement shaft is formed to secure contact between the base collar portion and the lower perimeter of the desired pistol grip by means of a friction fit between the engagement shaft and the cavity.

3. The pistol grip extender of claim 1, wherein the engagement shaft is formed to secure contact between the base collar portion and the lower perimeter of the desired pistol grip by means of a connecting feature disposed upon the engagement shaft.

4. The pistol grip extender of claim 3, wherein the connecting feature comprises a screw receiver.

5. The pistol grip extender of claim 3, wherein the connecting feature comprises a pressure fit member.

6. The pistol grip extender of claim 1, wherein exterior surfaces of the base collar portion are finished to replicate exterior surfaces of the desired pistol grip.

7. The pistol grip extender of claim 1, further comprising an alignment feature disposed along the engagement shaft and adapted to engage with a corresponding feature of the desired pistol grip.

8. The pistol grip extender of claim 1, further comprising an alignment feature disposed along the base collar portion and adapted to engage with a corresponding feature of the desired pistol grip.

9. The pistol grip extender of claim 1, further comprising an alignment feature disposed along a bottom perimeter of the base collar portion and adapted to receive a magazine base plate.

10. A system for increasing the grip area of a compact or sub-compact pistol, the system comprising:
a base portion, having a magazine channel formed through it, adapted to connect to the bottom of a desired pistol grip; and
a shaft, disposed along the base portion, adapted for insertion into a cavity along a backstrap portion of the desired pistol grip, and adapted to secure contact between the base portion and the desired pistol grip once fully inserted into the cavity.

11. The system of claim 10, wherein the shaft secures contact between the base portion and the desired pistol grip by friction fit within the cavity.

12. The system of claim 10, wherein the shaft secures contact between the base portion and the desired pistol grip utilizing a connecting feature disposed upon the engagement shaft.

13. The system of claim 12, wherein the connecting feature is adapted to receive a screw.

14. The system of claim 12, wherein the connecting feature is a pressure fit member.

15. The system of claim 10, wherein exterior surfaces of the base portion replicate exterior surfaces of the desired pistol grip.

16. The system of claim 10, wherein an alignment feature is disposed along the shaft and adapted to engage with a corresponding feature of the desired pistol grip.

17. The system of claim 10, wherein an alignment feature is disposed along the base portion and adapted to engage with a corresponding feature of the desired pistol grip.

18. The system of claim 10, wherein an alignment feature is disposed along a bottom perimeter of the base portion and adapted to receive a magazine base plate.

19. The system of claim 10, wherein the desired pistol grip is manufactured by Glock.

20. A method of extending the effective grip area of a pistol, the method comprising the steps of:
providing a base portion, having a magazine channel formed through it, and adapted to connect to the bottom of the pistol's grip area;
providing a shaft, disposed along the base portion, and adapted for insertion into a cavity within the pistol's grip area; and
fully inserting the shaft into the cavity, thereby securing contact between the base portion and the pistol's grip area.
